(19) United States
(12) Patent Application Publication
(10) Pub. No.: US 2005/0114143 A1
(43) Pub. Date: May 26, 2005

(54) Chatting system having secret attendance function and the method for operating the same

(76) Inventors: Jong-Kyung Kim, Seongnam-si (KR); Sun-Young Kwon, Seoul (KR)

Correspondence Address: Robert E. Bushnell;Suite 300, 1522 K Street, N.W., Washington, DC, 20005, US

(21) Appl. No.: 10/716,871

(22) Filed: Nov. 20, 2003

(51) Int. Cl. G10L 21/00

(52) U.S. Cl. 704/270.1

(57) ABSTRACT

The present invention relates to a chatting system having secret attendance function and the method for operating the same. The chatting system having secret attendance function comprises: an attendance list control system for checking that a connected attendant is a general attendant, or a public attendant, or a secret attendant and registering the attendant; a video control system for receiving video chatting data from the terminals of the connected general attendants; an audio control system for receiving audio chatting data from the terminals of the connected general attendants; and a text control system for receiving text chatting data from the terminals of the connected general attendants. In accordance with the present invention, the attendants in a chatting room cannot recognize the attendance of the secret attendants. In addition, the public attendance can be recognized, however, the public attendants can do text chatting only.

### BACKGROUND OF THE INVENTION

1. Field of the Invention

The present invention relates to a chatting system. In more detail, it relates to a chatting system, that enables various types of attendance by classifying the attendance of a chatting room into general attendance, public attendance, and secret attendance wherein the secret attendants can only audit the conversation, and the entire attendants can not recognize the attendance of the secret attendants, and the method for operating the same.

2. Description of the Related Art

Recently, as computer-communication is being rapidly developed, various kinds of communities are being built up. As one of the key-factors to formulate these kinds of communities, a so-called “chatting” is widely being used. Chatting can be performed by various types of methods from a common chatting that simply exchanges letters to a video chatting that exchanges pictures, voices, and texts at the same time.

In the conventional chatting in the prior art, a user, who intends to attend a chatting room, signifies his (or her) intention to the chief (moderator) of the chatting room, then the chief allows him to attend the chatting room or refuse his intention for attendance. In common chatting (i.e., a literal chatting), the number of maximum allowable attendance is generally 10-50. However, in the case of video chatting, the number of attendance is generally limited to ¼-⅕ of that of a common chatting. The reason is that, in the case of video chatting, the size of data is much larger than that of text data since it includes video data and audio data as well. Therefore, if the number of attendance is increased in a video chatting, the increased attendants' data should be also displayed on the monitor, and thus the picture quality is degraded and the chatting speed is decreased.

In general, the number of maximum allowable attendance in a chatting room is set by 10, and if a chatting room is filled up to the maximum allowable attendance, it is generally being recognized as a popular and interesting chatting room. And thus, numbers of users are often waiting in a waiting room for attending that kind of chatting room.

Besides, in a prior chatting system, when a user is newly attending a chatting room where conversation is being going on, he (or she) cannot participate in the conversation immediately because he (or she) does not know the conversation history. And thus, he (or she) is often forced to leave the room by the chief of the room. In addition, if there exist some frequent-come-and-go users without chatting in a chatting room, it is also undesirable for the chief (and the other attendants as well) of the room because the room becomes to be jumbled and the conversation flow is often being disturbed.

### SUMMARY OF THE INVENTION

The present invention is proposed to solve the problems of the prior art mentioned above. It is therefore the object of the present invention to provide a chatting system having secret attendance function that allows a user to attend a chatting room with an appropriate attendance mode by classifying the attendance mode into general mode, public mode, and secret mode.

It is another object of the present invention to provide a method for operating a chatting system having secret attendance function that transmits general-mode chatting data to public-mode attendants when a chatting room allows public-mode attendance, and transmits general-mode chatting data to secret-mode attendants when a chatting room allows secret-mode attendance.

To achieve the object mentioned above, the present invention provides a chatting system, having secret attendance function, constituted in a chatting server for controlling the video, audio, and text chatting between the users connected thereto through Internet, characterized by comprising: an attendance list control system for checking that a connected attendant is a general attendant, a public attendant, or a secret attendant and registering the attendant thereafter; a video control system for receiving video chatting data from the terminals of connected general attendants; an audio control system for receiving audio chatting data from the terminals of connected general attendants; and a text control system for receiving text chatting data from the terminals of connected general attendants.

In addition, the present invention also provides a method for providing a chatting service having secret attendance function, that provides video, audio, and text chatting between the users connected to a chatting server through Internet, characterized by comprising the steps of: (a) receiving a chatting room and a chatting mode from a connected attendant; (b) if the chatting mode of the attendant inputted in step (a) is general mode, receiving chatting data from the terminal of the attendant and transmitting the chatting data to the general-mode attendants; (c) if the chatting mode of the attendant inputted in step (a) is public mode and the chatting room allows public mode, transmitting the chatting data of step (b) to the terminals of the attendants being connected with public mode; and (d) if the chatting mode of the attendant inputted in step (a) is secret mode and the chatting room allows secret mode, transmitting the chatting data of step (b) to the terminals of the attendants being connected with secret mode.

The present invention yet also provides a method for providing a chatting service having secret attendance function, that provides video, audio, and text chatting between the users connected to a chatting server through Internet, characterized by comprising the steps of: (a) receiving a chatting room and a chatting mode from a connected attendant; (b) if the chatting mode of the attendant inputted in step (a) is general mode, receiving chatting data from the terminal of the attendant and transmitting the chatting data to the general-mode attendants; (c) if the chatting mode of the attendant inputted in step (a) is public mode, transmitting the chatting data of step (b) to the terminals of the attendants being connected with public mode; and (d) if the chatting mode of the attendant inputted in step (a) is secret mode, transmitting the chatting data of step (b) to the terminals of the attendants being connected with secret mode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view illustrating the overall structure of a chatting system having secret attendance function in accordance with an embodiment of the present invention;

FIG. 2 is a view illustrating the detailed structure of the chatting server described in FIG. 1;

FIG. 3 is a view illustrating an example of a chatting screen displayed on the general attendant's terminal, the public-attendant's terminal, or the secret attendant's terminal described in FIG. 1;

FIG. 4 is a view illustrating the detailed data transmission states between the chatting server and the attendants' terminals described in FIG. 1; and

FIG.5 is a flowchart for explaining the detailed operation procedures of the chatting server described in FIG. 1.

### DETAILED DESCRIPTION OF THE EMBODIMENTS

Hereinafter, referring to appended drawings, the preferred embodiments of the present invention are described in detail.

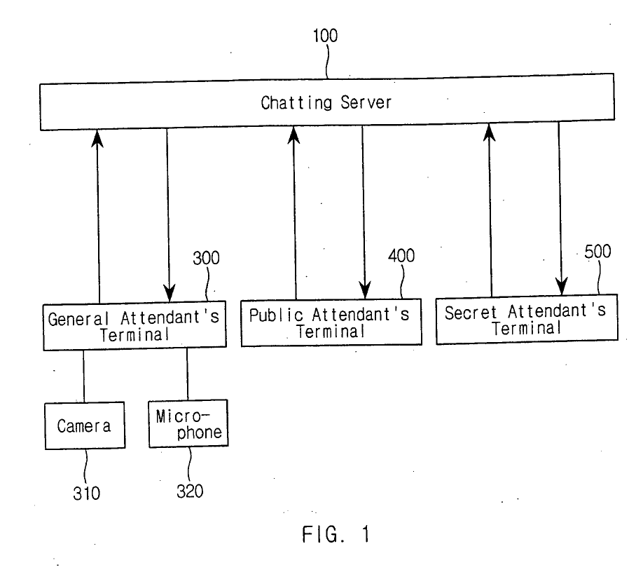

FIG. 1 is a view illustrating the overall structure of a chatting system having secret attendance function in accordance with an embodiment of the present invention. In the figure, the reference numeral 100 represents a chatting server, 300 represents a general attendant's terminal, 310 represents a camera, 320 represents a microphone, 400 represents a public attendant's terminal, and 500 represents a secret attendant's terminal.

The attendance in a chatting system having secret attendance function in accordance with an embodiment of the present invention is classified into general attendance, public attendance, and secret attendance. The general attendants can attend a chatting room to do video/audio/text chatting together. The public attendants can enter the chatting room, so they can audit the video/audio chatting being progressed in the room. But, they are allowed to do text chatting only. The attendance list of the public attendants is disclosed so that the entire attendants in the room can recognize who they are. On the other hand, the secret attendants can also enter the chatting room and audit the video/audio/text chatting being progressed in the room, however, the attendance list is not disclosed. Thus, the attendance of the secret attendants is not recognized by any of the attendants in the room including the secret attendants themselves.

As described in FIG. 1, a chatting server 100 is connected to a general attendant's terminal 300, a public attendant's terminal 400, and a secret attendant's terminal 500 through Internet. The terminals 300,400,500 of the attendants can be desktop computers, notebook computers, and/or the like. The general attendant's terminal 300 is equipped with a camera 310 for inputting the picture of the attendant and a microphone 320 for inputting the voice. In addition, the public attendant's terminal 400 and/or the secret attendant's terminal 500 can be equipped with a camera and a microphone as well.

The chatting server 100 controls the system to enable numbers of users, connected thereto through Internet, to create chatting rooms and enjoy free chatting in the created chatting rooms. Thus, the chatting server 100 receives the video, audio, and text data from numbers of attendants in a chatting room and transmits the data to each attendant's terminal in the chatting room.

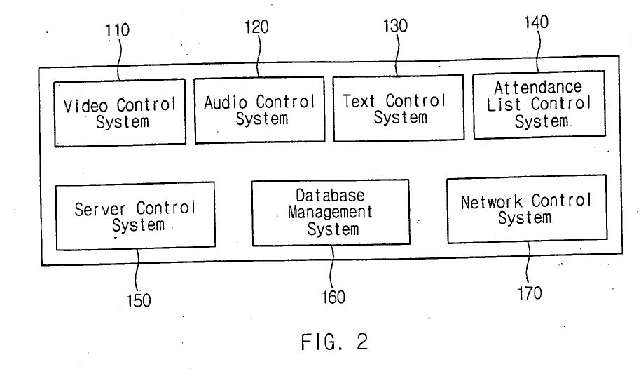

FIG. 2 is a view illustrating the detailed structure of the chatting server described in FIG. 1. In the figure, the reference numeral 110 represents a video control system, 120 represents an audio control system, 130 represents a text control system, 140 represents an attendance list control system, 150 represents a server control system, 160 represents a database management system, and 170 represents a network control system.

The attendance list control system 140 registers the information on the general, public, and secret attendants attending each chatting room created in the chatting server 100 and transmits the information, informing that each individual attendant is a general attendant, a public attendant, or a secret attendant, to the video control system 1 10, the audio control system 120, and the text control system 130.

Then, the video control system 110 controls the video data received from the terminals 300 of the general attendants in a chatting room to be transmitted to the entire attendants in the chatting room. In other words, the video control system 110 transmits the video data to the corresponding attendants according to the information on the attendants received from the attendance list control system 140. At this time, the video control system 110 receives video data from the terminals 300 of the general attendants, but does not receive video data from the terminals 400, 500 of the public attendants and the secret attendants. Then, the video control system 110 transmits the video data received from the terminals 300 of the general attendants to the entire attendants (general, public, and secret) attending the chatting room. Therefore, the public attendants and the secret attendants, attending a chatting room, can watch the video chatting being going on between the general attendants in the chatting room.

The audio control system 120 controls the audio data received from the terminals 300 of the general attendants in a chatting room to be transmitted to the entire attendants in the chatting room. In other words, the audio control system 120 transmits the audio data to the corresponding attendants according to the information on the attendants received from the attendance list control system 140. At this time, the audio control system 120 receives audio data from the terminals 300 of the general attendants, but does not receive audio data from the terminals 400, 500 of the public attendants and the secret attendants. Then, the audio control system 120 transmits the audio data received from the terminals 300 of the general attendants to the entire attendants (general, public, and secret) attending the chatting room. Therefore, the public attendants and the secret attendants, attending a chatting room, can hear the audio chatting being going on between the general attendants in the chatting room.

The text control system 130 controls the text data (chatting data) received from the terminals 300 of the general attendants in a chatting room to be transmitted to the entire attendants in the chatting room. In other words, the text control system 130 transmits the text data to the corresponding attendants according to the information on the attendants received from the attendance list control system 140. At this time, the text control system 130 receives text data from the terminals 300, 400 of the general attendants and the public attendants, but does not receive text data from the terminals 500 of the secret attendants. Then, the text control system 130 transmits the text data received from the terminals 300 of the general attendants to the entire attendants (general, public, and secret) attending the chatting room. Therefore, the public attendants and the secret attendants, attending a chatting room, can watch the text chatting being going on between the general attendants in the chatting room.

The database management system 160 stores the data of the user information, the chatting information, and the items provided for the chatting.

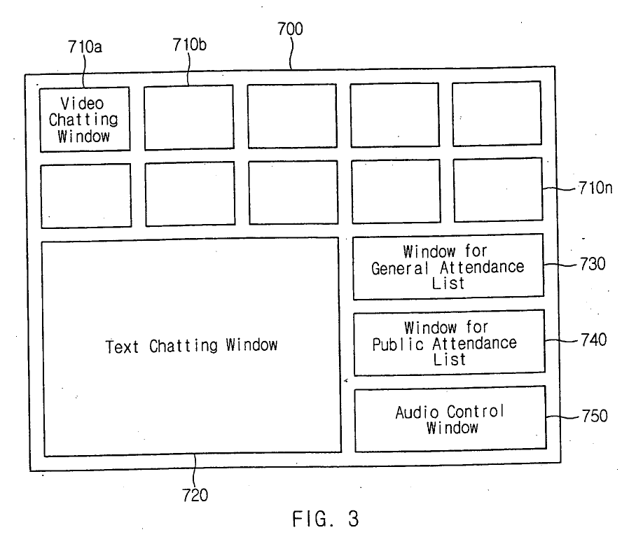

FIG. 3 is a view illustrating an example of a chatting screen displayed on the general attendant's terminal 300, the public attendant's terminal 400, or the secret attendant's terminal 500 described in FIG. 1. In the figure, the reference numeral(s) 710a˜710n represent attendants' video chatting windows, 720 represents a text chatting window, 730 represents a window for general attendance list, 740 represents a window for public attendance list, and 750 represents an audio control window.

As described in the figure, on the screen of the terminal of each attendant (general, public, or secret) attending a chatting room, video chatting windows 710a˜710n for displaying the pictures received from the cameras of the general attendants are appeared. Thus, the entire attendants in the chatting room can watch the pictures of the general attendants. In this embodiment of the present invention, the number of video chatting windows is set to be 10.

As described in the same figure, the contents of text chatting, going on between the general attendants of the chatting room, are displayed on the text chatting window 720 located at the lower-left of the chatting screen. The list of general attendants attending the chatting room is displayed on the window 730 for general attendance list located at mid-right of the chatting screen. Besides, the list of public attendants attending the chatting room is displayed on the window 740 for public attendance list located under the window 730 for general attendance list. However, the secret attendance list is not displayed on the chatting screen.

In addition, a control button for controlling the volume of the output sound of the audio chatting is displayed on the audio control window 750 located at lower-right of the chatting screen.

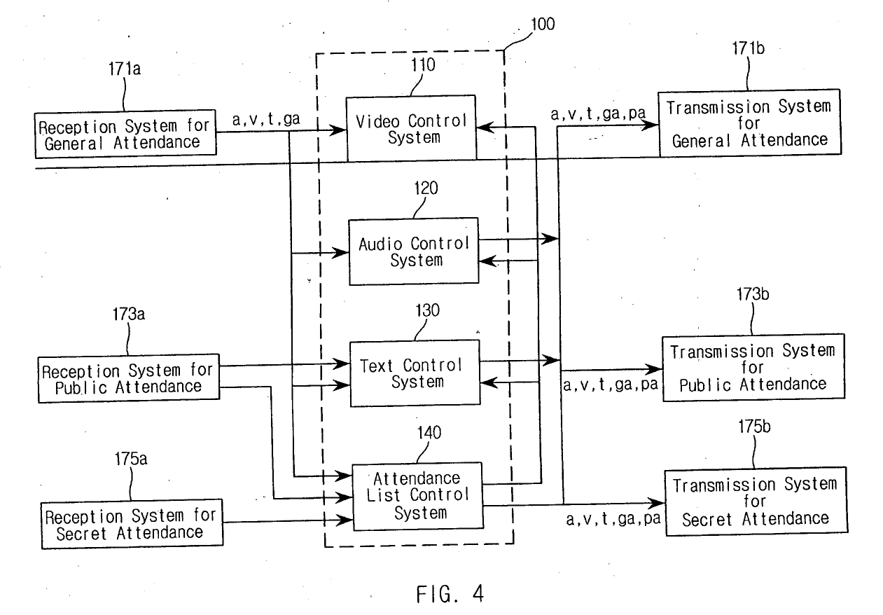

FIG. 4 is a view illustrating the detailed data transmission states between the chatting server 100 and the attendants' terminals 300˜500 described in FIG. 1. In the figure, the reference numeral 110 represents a video control system, 120 represents an audio control system, 130 represents a text control system, 140 represents an attendance list control system, 171a represents a reception system for general attendance, 171b represents a transmission system for general attendance, 173a represents a reception system for public attendance, 173b represents a transmission system for public attendance, 175a represents a reception system for secret attendance, and 175b represents a transmission system for secret attendance.

As described in the figure, the reception system 171a for general attendance receives video chatting data(v), audio chatting data(a), text chatting data(t), and general attendance identification data(ga) from the terminals 300 of the general attendants. Then, the reception system 171a for general attendance transmits the video chatting data(v), received from the terminals 300 of the general attendants, to the video control system 110, the audio chatting data(a) to the audio control system 120, the text chatting data(t) to the text control system 130, and the general attendance identification data(ga) to the attendance list control system 140 respectively.

On the other hand, the reception system 173a for public attendance receives text chatting data(t) and public attendance identification data(pa) from the terminals 400 of the public attendants. Then, the reception system 173a for public attendance transmits the text chatting data(t), received from the terminals 400 of the public attendants, to the text control system 130 and the public attendance identification data(pa) to the attendance list control system 140 respectively. The reception system 175a for secret attendance receives secret attendance identification data(sa) from the terminals 500 of the secret attendants. Then, the reception system 175a for secret attendance transmits the public attendance identification data(pa) received from the terminals 500 of the secret attendants to the attendance list control system 140.

The attendance list control system 140 receives the general attendance identification information(ga) from the reception system 171a for general attendance, the public attendance identification information(pa) from the reception system 173a for public attendance, and the secret attendance identification information(sa) from the reception system 175a for secret attendance. Then, the attendance list control system 140 transmits the control signals for the attendants, according to the received each attendant's identification information, to the video control system 110, the audio control system 120, and the text control system 130. In addition, the attendance list control system 140 extracts the user-IDs of the general attendants and the public attendants from the database, based on the general attendance identification information(ga) received from the reception system 171a for general attendance and the public attendance identification information(pa) received from the reception system 173a for public attendance, and transmits the extracted user-IDs to the transmission system 171b for general attendance, the transmission system 173b for public attendance, and the transmission system 175b for secret attendance.

Based on the control signals for the attendants from the attendance list control system 140, the video control system 110 transmits the video chatting data(v), received from the reception system 171a for general attendance, to the transmission system 171b for general attendance, the transmission system 173b for public attendance, and the transmission system 175b for secret attendance. Similarly, based on the control signals for the attendants from the attendance list control system 140, the audio control system 120 transmits the audio chatting data(a), received from the reception system 171a for general attendance, to the transmission system 17 lb for general attendance, the transmission system 173b for public attendance, and the transmission system 175b for secret attendance. And, based on the control signals for the attendants from the attendance list control system 140 as well, the text control system 130 transmits the text chatting data(t), received from the reception system. 171a for general attendance, to the transmission system 171 b for general attendance, the transmission system 173b for public attendance, and the transmission system 175b for secret attendance.

Finally, the transmission system 171b for general attendance transmits the video data, the audio data, the text data, the general attendants' IDs, and the public attendants' IDs to the terminals 300 of the general attendants attending the chatting room. In other words, the transmission system 171b for general attendance transmits the general attendants' IDs and the public attendants' IDs transmitted from the attendance list control system 140 to the terminals 300 of the general attendants in the chatting room. Also, the transmission system 171b for general attendance transmits the video data from the video control system 110, the audio data from the audio control system 120, and the text data from the text control system 130 to the terminals 300 of the general attendants in the chatting room. Similarly, the transmission system 173b for public attendance and the transmission system 175b for secret attendance transmit the video data, the audio data, the text data, the general attendants' IDs, and the public attendants' IDs to the terminals 400 of the public attendants and the terminals 500 of the secret attendants respectively.

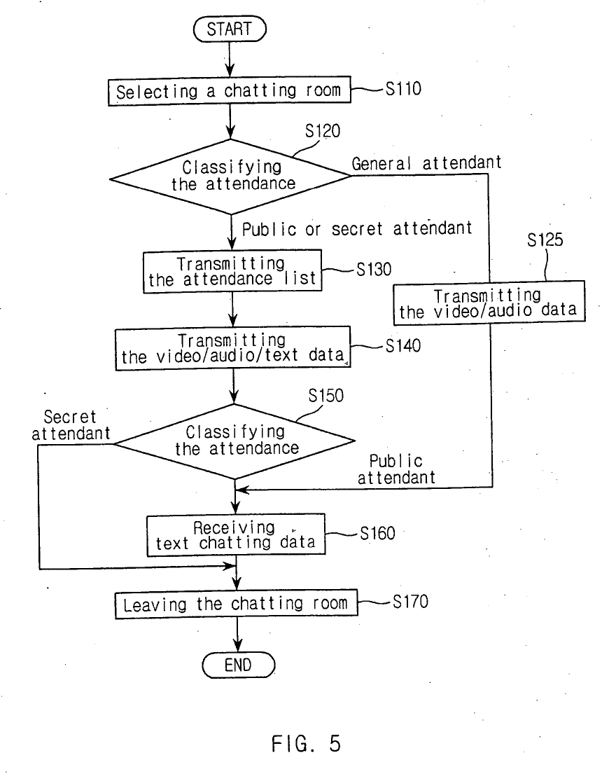

FIG. 5 is a flowchart for explaining the detailed operation procedures of the chatting server 100 described in FIG. 1.

The chatting server 100 first displays a list of the created chatting rooms on the chatting screen of the terminals 300˜500 of the attendants connected thereto through Internet and asks each attendant to select a chatting room. At this time, the attendant can also create a new chatting room. If the attendant selects a chatting room on the displayed chatting room list, the chatting server recognizes the selected chatting room S110.

Next, the chatting server 100 checks that the connected attendant is a general attendant, a public attendant, or a secret attendant S120. In this step, the chatting server 100 can classify the attendant based on the user-ID and the password inputted by the attendant through his (or her) terminal. It can be constituted in a way that, if the selected chatting room is not set to allow public attendance or secret attendance, a public attendant or a secret attendant cannot attend the chatting room. On the other hand, if the selected chatting room is set to allow public attendance or secret attendance, the attendant can attend the chatting room with changing his (or her) attending mode as a general, public, or secret mode. Thus, when a user is newly joining a chatting room, he (or she) can attend the chatting room in a public attendance mode at first, an then change the mode into a general attendance mode to participate in the chatting after figuring the conversation flow.

In case that the attendant is classified to be a general attendant in step S120, the chatting server 100 controls that the attendant can perform video/audio chatting with the attendants in the chatting room S125, and then controls that the attendant can perform text chatting as well S160. So, a free chatting can be accomplished between the attendants, who attend the chatting room in general attendance mode.

On the other hand, in case that the attendant is classified to be a public or a secret attendant in step S120, the chatting server 100 first transmits the general attendance list and the public attendance list to the terminal of the attendant S130. The transmitted general attendance list is displayed on the window 730 for general attendance list of the chatting screen, and the public attendance list is displayed on the window 740 for public attendance list of the chatting screen. Next, the chatting server 100 transmits the video/audio/text chatting data between the general attendants to the terminal of the attendant S140.

Then, the transmitted video chatting data is displayed on the video chatting windows 710a˜710n of the chatting screen of the attendant's terminal. And, the transmitted audio chatting data is vocally outputted through the speaker(s) of the attendant's terminal. In addition, the transmitted text chatting data is displayed on the text chatting window 720 of the chatting screen of the attendant's terminal. Next, the chatting server 100 checks that the attendant is a public attendant or a secret attendant S150, and in the case of a public attendant, it allows the attendant a text chatting and receives text chatting data from the attendant S160.

As mentioned thereinbefore, a chatting system of the present invention classifies the attendance in a chatting room into various modes and controls them. Thus, in accordance with the present invention, the attendants in a chatting room cannot recognize the attendance of the secret attendants. In addition, the public attendance can be noticed, however, the public attendants cannot fully participate in the conversation.

Moreover, in accordance with the present invention, a user can audit the conversation in a chatting room before actively attending the room, and thus he (or she) can figure the conversation flow first, and decide to join the room or not thereafter.

Besides, in case that a meeting is being held through a chatting system, the present invention substantially provides a selection on the options for an open (public) meeting and a closed (secret) meeting, and thus numbers of related and/or concerned people can attend the meeting.

Since those having ordinary knowledge and skill in the art of the present invention will recognize additional modifications and applications within the scope thereof, the present invention is not limited to the embodiments and drawings described above. The scope of the present invention is therefore to be represented by the claims that will be described hereinafter, and it is needless to say that the claims of the present invention are to be interpreted to include all the non-inventive modifications and applications able to be derived from the subjects of themselves and their equivalents.

1. A chatting system, having secret attendance function, constituted in a chatting server for controlling the video, audio, and text chatting between the users connected to Internet through their terminals, characterized by comprising:
an attendance list control system for checking that each of the connected attendant is a general attendant, a public attendant, or a secret attendant and registering the attendant thereafter;
a video control system for receiving video chatting data from the terminals of the connected general attendants;
an audio control system for receiving audio chatting data from the terminals of the connected general attendants; and
a text control system for receiving text chatting data from the terminals of the connected general attendants.

2. A chatting system having secret attendance function as claimed in claim 1, characterized in that said attendance list control system transmits control signals, each of which indicates that each of said connected attendants is a general attendant, a public attendant, or a secret attendant, to said video control system, said audio control system, and said text control system.

3. A chatting system having secret attendance function as claimed in claim 1, characterized in that said attendance list control system transmits the list of general attendance and the list of public attendance, connected to said chatting server, to the terminals of the general attendants and the public attendants and the secret attendants.

4. A chatting system having secret attendance function as claimed in claim 1, characterized in that said video control system transmits said video chatting data, received from the terminals of the general attendants connected to said chatting server, to the terminals of the general attendants, the public attendants, and the secret attendants.

5. A chatting system having secret attendance function as claimed in claim 1, characterized in that said audio control system transmits said audio chatting data, received from the terminals of the general attendants connected to said chatting server, to the terminals of the general attendants, the public attendants, and the secret attendants.

6. A chatting system having secret attendance function as claimed in claim 1, characterized in that said text control system transmits said text chatting data, received from the terminals of the general attendants connected to said chatting server, to the terminals of the general attendants, the public attendants, and the secret attendants.

7. A method for providing a chatting service having secret attendance function, that provides video, audio, and text chatting between the users connected to Internet through their terminals, characterized by comprising the steps of:
(a) receiving a chatting room and a chatting mode from a connected attendant;
(b) if the chatting mode of said attendant inputted in said step (a) is general mode, receiving chatting data from the terminal of said attendant and transmitting said chatting data to the general-mode attendants;
(c) if the chatting mode of said attendant inputted in said step (a) is public mode and said chatting room allows public mode, transmitting said chatting data of step (b) to the terminals of the attendants being connected with public mode; and
(d) if the chatting mode of said attendant inputted in said step (a) is secret mode and said chatting room allows secret mode, transmitting said chatting data of step (b) to the terminals of the attendants being connected with secret mode.

8. A method for providing a chatting service having secret attendance function as claimed in claim 7, characterized in that said steps of transmitting said chatting data include transmitting video data, audio data, and/or text data.

9. A method for providing a chatting service having secret attendance function as claimed in claim 7, characterized in that said step (a) further comprises the step of transmitting the list information on the attendants connected with general mode to the terminals of the general attendants and the public attendants and the secret attendants.

10. A method for providing a chatting service having secret attendance function as claimed in claim 7, characterized in that said step (b) further comprises the step of transmitting the list information on the attendants connected with public mode to the terminals of the general attendants and the public attendants and the secret attendants.

11. A method for providing a chatting service having secret attendance function, that provides video, audio, and text chatting between the users connected to Internet through their terminals, characterized by comprising the steps of:
(a) receiving a chatting room and a chatting mode from a connected attendant;
(b) if the chatting mode of said attendant inputted in said step (a) is general mode, receiving chatting data from the terminal of said attendant and transmitting said chatting data to the general-mode attendants;
(c) if the chatting mode of said attendant inputted in said step (a) is public mode, transmitting said chatting data of step (b) to the terminals of the attendants being connected with public mode; and
(d) if the chatting mode of said attendant inputted in said step (a) is secret mode, transmitting said chatting data of step (b) to the terminals of the attendants being connected with secret mode.

12. A method for providing a chatting service having secret attendance function as claimed in claim 11, characterized in that said steps of transmitting said chatting data include transmitting video data, audio data, and/or text data.

13. A method for providing a chatting service having secret attendance function as claimed in claim 11, characterized in that said step (a) further comprises the step of transmitting the list information on the attendants connected with general mode to the terminals of the general attendants.

14. A method for providing a chatting service having secret attendance function as claimed in claim 11, characterized in that said step (a) further comprises the step of transmitting the list information on the attendants connected with general mode to the terminals of the public attendants.

15. A method for providing a chatting service having secret attendance function as claimed in claim 11, characterized in that said step (a) further comprises the step of transmitting the list information on the attendants connected with general mode to the terminals of the secret attendants.

16. A method for providing a chatting service having secret attendance function as claimed in claim 11, characterized in that said step (b) further comprises the step of transmitting the list information on the attendants connected with public mode to the terminals of the general attendants.

17. A method for providing a chatting service having secret attendance function as claimed in claim 11, characterized in that said step (b) further comprises the step of transmitting the list information on the attendants connected with public mode to the terminals of the public attendants.

18. A method for providing a chatting service having secret attendance function as claimed in claim 11, characterized in that said step (b) further comprises the step of transmitting the list information on the attendants connected with public mode to the terminals of the secret attendants.
